(19) United States
(12) Patent Application Publication
(10) Pub. No.: US 2003/0090644 A1
(43) Pub. Date: May 15, 2003

(54) Mask and exposure apparatus

(75) Inventor: Masahiro Nei, Yokohama-shi (JP)

Correspondence Address: OLIFF & BERRIDGE, PLC, P.O. BOX 19928, ALEXANDRIA, VA, 22320, US

(73) Assignee: NIKON CORPORATION, CHIYODA-KU (JP)

(21) Appl. No.: 10/318,133

(22) Filed: Dec. 13, 2002

Related U.S. Application Data
(63) Continuation of application No. 09/688,963, filed on Oct. 17, 2000, now abandoned.

(51) Int. Cl. G03B 27/72

(52) U.S. Cl. 355/69; 355/53; 355/67; 430/5; 430/20; 430/22

(57) ABSTRACT

A mask R having a pattern illuminated by exposure light is used in measuring the change in the amount of exposure light, and provides measuring fields 38a and 38b that transit a part of the exposure light. As a result, light exposure control can be carried out accurately and simply while the mask is mounted.

### BACKGROUND OF THE INVENTION

1. Field of the Invention

The present invention relates to mask having a pattern that is transferred, for example, to a semiconductor device or a liquid crystal display device, and an exposure apparatus that transfers by exposure the pattern of the mask to the substrate using photolithographic technology. This specification incorporates Japanese Patent Application, No. 11-214411, the contents of which are referred to by reference.

2. Description of the Prior Art

Generally, when producing, for example, a semiconductor device or a liquid crystal display device using a photolithographic technology, an exposure apparatus is used that exposes a substrate having a photosensitive substance applied thereto to a pattern of a reticle (mask) directly, or at a predetermined reduced or enlarged magnification. Because an appropriate light exposure for this photosensitive substance has been determined, in a conventional exposure apparatus, a beam splitter is disposed within the illuminating optical system of the exposure light, and the light exposure on a substrate such as a wafer is monitored by monitoring the amount of the exposure light split off by this beam splitter. In addition, depending on the result of this monitoring, light exposure control is carried out such that this appropriate light exposure is attained.

In connection with the above, recently, accompanying the increasing density of semiconductor devices, for example, the line width of the circuit patterns is also becoming more refined. Due to this, an exposure apparatus having a larger aperture number, for example, has been developed for a reduction projection type exposure apparatus. However, in order to respond to further increasing density of semiconductor devices, etc., a further reduction of the wavelength of the exposure light is necessary.

Thus, in place of the presently widely used exposure light having a ‘g’ line (with a wavelength of 436 nm), or ‘i’ line (with a wavelength of 365 nm) emitted from a mercury lamp, excimer laser light having an even shorter wavelength is coming to be used. While the wavelength differs depending on the type of gas serving as the oscillating medium of the laser source, for example, utilizing as an excimer laser light one with a wavelength of 248 nm using krypton fluoride (KrF) as an oscillating medium or one having a wavelength of 193 nm using argon fluoride (ArF) as an oscillating medium are under investigation.

However, in the case of using an excimer laser as the exposure light, it has been shown that the optical characteristics (for example, the light transmittance) of the glass and coating films of the optical elements of the illumination optical system or projection optical system for the exposure light gradually fluctuate due to the illumination of the excimer laser. FIG. 5 shows the fluctuation of light transmittance properties in the optical system as a function of time. As shown in this figure, in the wavelength field shorter than the wavelength of KrF excimer laser light, the light transmittance of the optical system falls immediately once the illumination by the laser light has finished. The reason for this is that the light transmittance of the optical elements themselves fluctuates due to the illumination of the laser light.

In addition, the light transmittance that has fallen significantly after the illumination by the laser light subsequently gradually rises, and after the passage of a certain amount of time, reaches a state of substantially complete saturation. The reason for this is the occurrence of what is known as light cleaning. Light cleaning is the elimination of hydrous and organic materials adhering to the optical elements from the surfaces thereof due to the illumination of the laser light.

In contrast, the fluctuation of the light transmittance in the case that the exposure processing is suspended due to a wafer replacement operation, for example, is shown by the dotted line. At time t1, when the illumination by the laser light is suspended, the light cleaning in the optical elements is also suspended, and the free-floating contaminants in the optical system that were previously removed adhere again to the surface of the optical elements. Thus, the light transmittance of the optical elements themselves fluctuates and falls. At time t2, when the illumination by the laser light is restarted, the light transmittance increases because the optical elements are again subject to light cleaning. In this manner, in the case that excimer laser light is used as an exposure light, the light transmittance of the optical elements fluctuates even during a short time interval.

Therefore, the ratio of the amount of the excimer laser light (amount of energy) split by the beam splitter and the amount of excimer laser light arriving at the wafer fluctuates. Thus, when the above light exposure control is carried out on the assumption that this ratio is constant, the difference between the actual light exposure and the appropriate light exposure exceeds predetermined tolerance values. In order to avoid this type of problem, an exposure apparatus is known that compensates the sensitivity of the light amount monitor in the optical illumination system by second light receiving elements disposed in proximity to the wafer.

However, the following problems occur in the conventional masks and exposure apparatus described above.

When compensating the sensitivity of the light amount monitor in the illuminating optical system, the reticle (mask) actually used during exposure must be replaced by a dedicated test reticle having a pattern used for sensitivity correction, and the reticle must be removed from the reticle stage. However, because the production efficiency falls when frequently carrying out sensitivity correction of the light amount monitor in response to fluctuations in the transitivity even during a short time interval, as described above, the compensation timing is limited in fact to the time during the replacement of the reticle.

Thus, European Patent Application, First Publication, No. 0766144, for example, discloses technology for resolving this problem. In this technology, by providing a transmission part that transmits the exposure light to a reticle stage that retains the reticle, even if the reticle is not replaced or removed, the amount of exposure light that the transmitting part transmits can be monitored by the above-mentioned second receiving optical elements.

However, even though the wafer is illuminated by the exposure light that transits the reticle, in this technology monitors the exposure light that does not transit the reticle. Accurate light exposure control cannot be carried out only by monitoring the exposure light that has not transited a reticle because the amount of exposure light arriving at the wafer differs depending on whether it transits or does not transit a reticle.

Thus, monitoring the amount of light by the exposure light transiting the reticle actually used during exposure can be considered, but because the patterns formed in each reticle differ, the exposure light fluctuation depends on the pattern at the transmission location. In addition, as in the case of the reticle used to form contact holes, there are cases-where-the pattern field is illuminated across the entire surface, and thus monitoring the exposure light transiting the reticle is not easy.

In addition, in the above-described technology, because the reticle stage must be moved so that the transmission part is in the path of the exposure light, the movement stroke of the reticle stage must be made long, and there is the problem that this invites an increase in the size of the apparatus and an increase in the cost.

In consideration of the above points, it is an object of the present invention to provide a mask and exposure apparatus in which the movement stroke of the stage does not become long, and in which the light exposure control can be carried out accurately and simply while the mask is mounted.

### SUMMARY OF THE INVENTION

In order to attain the above objects, the following structure corresponding to FIG. 1 through FIG. 4 showing the embodiments was used for the present invention.

The mask of the present invention is a mask (R) that has a pattern illuminated by exposure light and provides measuring fields (381, 38b, 40a-40f) that allow a portion of the exposure light to transit for use in measuring the amount of light exposure.

In this mask (R), even when the pattern of each mask (R) is different, a part of the exposure light used in the measurement of the amount of light can transit the measuring fields (38a, 38b, and 40a-40f) while the mask (R) is mounted. As a result, in addition to eliminating the necessity of replacing the mask (R) during measurement, the amount of exposure light that actually transits the mask (R) can be measured, and thereby high precision light exposure control can be carried out. Furthermore, there are the effects that measurement of the amount of light can be carried out frequently, and there is the effect that even if the light transmittance fluctuates due to light cleaning, the target illumination on the substrate (W) can be easily and reliably maintained.

In addition, by setting the measuring fields (38a, 38b, and 40a-40f) outside the pattern field (36), even in the case that nearly the entire pattern field (36) is illuminated, as in the case of a mask for forming contact holes, exposure light transits, and the amount of exposure light can be accurately measured. In this case, by setting the measuring fields (38a, 39b, and 40a-40f) so as to surround the pattern field (36) on both sides, during measurement, the exposure light can transit the measuring fields (38a, 38b, and 40a-40f) positioned closer together. In this case, even when the mask (R) is moved in order to measure the amount of light, the measuring fields close to the optical axis of the exposure light can be selected, and thus the effects can be attained that the distance of the movement of the mask (R) becomes shorter and an improvement in the cycle time of the exposure process can be realized. Furthermore, by setting the measuring fields (38a, 39b, and 40a-40f) in proximity to the center of the pattern field (36), measurement can be carried out in proximity to the center of the optical system, and the light exposure can be controlled more precisely.

Furthermore, a plurality of measuring fields (38a, 39b, and 40a-40f) can be set along the pattern field (36). In this case, a measurement that averages the amount of exposure light that transits each of the measuring fields (38a, 39b, and 40a-40f) becomes possible. As a result, the amounts of light that reduce the influence of distortions of the optical elements, etc., can be found, and the amount of exposure light can be controlled with higher precision.

In addition, the exposure apparatus (1) of the present invention provides a mask stage (23) holding a mask (R) having a pattern, and an illumination optical system that illuminates the mask (R) by exposure light, and transfers a pattern of the mask (R) to a substrate (W), and is characterized in the mask (R) of the present invention being held on the mask stage (23), and is further characterized in providing a first receiving optical means that receives a part of the exposure light illuminating the mask (R), a second receiving optical means that receives the exposure light that transits the measuring fields of the mask (R), and a light amount compensation means (16) that compensates the amount of exposure light based on the output signal of the first receiving optical means (15) and the second receiving optical means (33).

In this exposure apparatus, by positioning the measuring fields (38a, 39b, and 40a-40f) of the mask (R) in the optical path of the exposure light by moving the mask stage (23), a part of the exposure light will transit the mask even while the mask (R) is mounted in the mask stage (23). In addition, the light amount correction means (16) compensates that amount of exposure light based on the exposure light illuminating the mask (R) and the exposure light that has transited the measuring fields (38a, 38b, and 40a-40f) of this mask (R).

Thereby, in addition to eliminating the necessity of replacing the mask (R) for each measurement, the amount of exposure light that has actually transited the mask (R) can be measured, and the amount of exposure light can be controlled with higher precision. In addition, carrying out frequent measurement of the amount of light can be carried out, and even if the light transmittance fluctuates due to light cleaning, the target illumination on the substrate (W) can be easily and reliably maintained.

A structure can be used wherein the light amount compensation means (16) can predict the fluctuation properties of the amount of exposure light through time, and the amount of light compensated is based on this prediction. In this case, even if the light transmittance of the illuminating optical system and projection optical system fluctuates during exposure and while the apparatus is suspended, the effects are attained that the illumination on the substrate is compensated by an appropriate value, and the cumulative amount of light (the exposure dose) of the exposure light on the substrate can be always be compensated at an appropriate value depending on the sensitivity of the substrate.

### BRIEF DESCRIPTION OF THE DRAWINGS

FIG. 1 is a planar drawing of the reticle whose measuring fields are set outside the pattern field according to the first embodiment of the present invention.

FIG. 2 is a drawing showing a schematic construction of the exposure apparatus according to the first embodiment of the present invention.

FIG. 3 is a relational drawing showing the relationship between exposure time and light transmittance according to the first embodiment of the present invention.

FIG. 4 is a planar drawing of the reticle having a plurality of measuring fields along the non-scanning direction outside the pattern field.

FIG. 5 is a time change property diagram showing the relationship between the time passage and light transmittance from the beginning of the exposure.

### PREFERRED EMBODIMENTS

First Embodiment

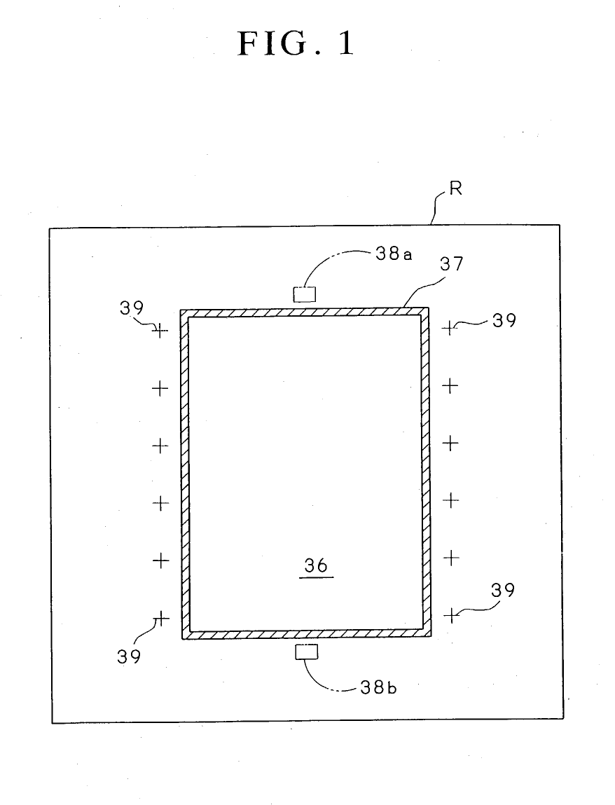

Below, a first embodiment of the mask and exposure apparatus of the present invention is explained referring to FIG. 1 through FIG. 3.

Here, an example is explained wherein the substrate is a wafer used for semiconductor device fabrication and the exposure apparatus is a scanning exposure apparatus that exposes by scanning the pattern of a reticle onto a wafer by moving in synchronism the reticle and the wafer.

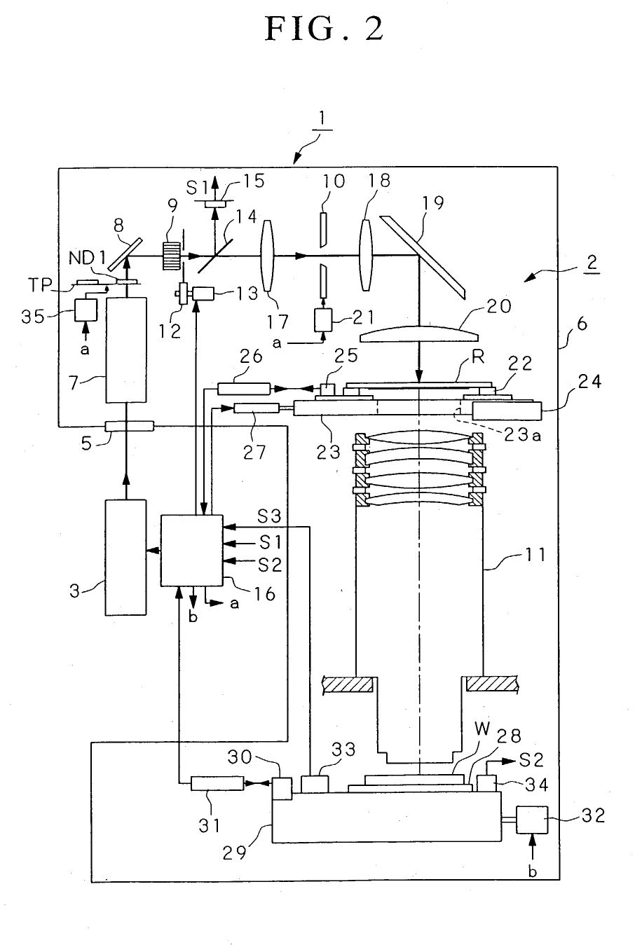

FIG. 2 is a drawing showing a schematic construction of the exposure apparatus 1 according to the present invention. As shown in this figure, a substantially parallel beam of laser light (exposure light) is emitted from an ArF excimer laser light source 3 that is provided outside the exposure apparatus body 2 and that generates pulsed light having an output wavelength of, for example, 193 nm, which is guided to an optically transmitting window 5 of the exposure apparatus body 2.

Here, the exposure apparatus body 2 is accommodated in a chamber 6, and controlled so as to maintain a constant temperature. The laser light that transits the optically transmitting window 5 is shaped into a form having a predetermined cross-section, is reflected by a reflecting mirror 8 after transiting one of a plurality of ND filters (in FIG. 2, ND 1) provided on a turret platform and having mutually differing light transmittances (attenuation rates), and is guided to a fly-eye lens 9 that serves as an optical integrator. The fly-eye lens 9 is structured so that a plurality of lens elements are bound together, and a plurality of developments (secondary light sources) are formed at the emitting surface of these lens elements corresponding to the number of the lens elements that form the fly-eye lens 9.

The turret plate TP holds six ND filters ND 1 to ND 6 (ND 1 and ND 2 are illustrated), and by rotating the turret plate TP using a motor 35, the respective six ND filters can be selectively disposed into the illumination optical system. The ND filters ND1-ND6 are determined, for example, by the sensitivity of the resist on the wafer W, the variation in the generation strength of the light source 3, and the control precision of the light exposure (the exposure dose) on the wafer, and are suitably selected depending on the number of pulse beams (exposure pulse number) that should illuminate one point on the wafer during scanning exposure. The exposure pulse number represents the number of pulsed beams that illuminate one point when that one point on the wafer W crosses the illumination field on the reticle R defined by the variable field stop (the reticle blind) and the conjugate field related to the projecting optical system along the scanning direction (the direction of synchronous movement).

Furthermore, instead of the turret plate TP in FIG. 2, two plates respectively having a plurality of slits can be disposed opposite each other, and by moving these two plates relative to each other in the direction of the arrangement of the slits, the intensity of the pulsed light can be regulated.

In addition, the light source 3 generates a pulsed light depending on a trigger pulse sent from a light source control circuit (not illustrated), and at the same time, the light source control circuit regulates the voltage (charge voltage) applied to the light source 3, and regulates the intensity of the pulsed light emitted from the light source 3. In addition, in the present embodiment, the intensity of the pulsed light on the reticle R, that is, the wafer W (i.e., the cumulative amount of light) can be regulated by regulating at least one of either the intensity of the generation of the light source 3 by the light source control circuit and the light transmittance (attenuation rate) of the pulsed light by the turret plate TP. Moreover, the light source control circuit controls the light source 3 following commands from the main controller (the light amount compensation means) 16 that comprehensively controls the entire exposure apparatus.

At the positions of the plurality of secondary light sources formed by the fly-eye lenses 9, a turret plate 12, having a plurality of aperture stops with mutually differing shapes and sizes, is disposed. The turret plate 12 is rotated by a motor 13, and one aperture stop is chosen depending on the pattern of the reticle R to be transferred onto the wafer W, and inserted into the light path of the illuminating optical system. The turret plate 12 and the motor 13 form the illuminating system variable aperture stop.

The light beam from the secondary light source formed by the fly-eye lens 9 transits the variable aperture stop of the turret plate 12 and is split into two light beams by the beam splitter 14, the reflected light that is one part of the light beam is received at the integrator sensor (the first receiving light means) 15, and the intensity of the illumination (strength) of the illumination system is detected. Moreover, the integrator sensor 15 is disposed on the face conjugate to the wafer W. The signal S1 depending on the detected illumination intensity is input into the main controller 16.

In contrast, the transmitted light that transits the beam splitter 14 transits a relay lens 17, a variable field stop 10 that defines a rectangular opening, and a relay lens 18, is next reflected by the reflecting mirror 19, and then is converged by the condenser optical system 20 formed by refractive optical elements, such as a plurality of lenses. Thereby, the illumination field on the reticle R that is defined by the opening of the variable field stop 10 is substantially evenly illuminated by the plurality of superimposed lights. In addition, the image of the circuit pattern on the reticle R is formed on the wafer W by the projection optical system 11, the resist applied to the wafer W reacts to the light, and the circuit pattern image is transferred onto the wafer W.

Moreover, by moving at least one blade that forms the variable field stop 10 using the motor 21, the shape and size of the rectangular opening of the variable field stop 10 can be modified. In particular, by modifying the width of the short side of the rectangular opening, the width in the scanning direction of the illumination field on the reticle R can be changed. Thereby, the cumulative amount of light (the exposure dose) of the plurality of pulsed lights that illuminate one point on the wafer W by the scanning exposure can be regulated. In addition, the sum of the amount of the pulsed lights that illuminate one point on the wafer W during scanning exposure can be regulated even when the scanning speeds of the wafer W and the reticle R are modified. The reason for this is that when one point on the wafer W crosses the illumination field on the reticle R and the conjugate projection field along the scanning direction, the number of pulsed lights illuminating this one point is modified.

This means that in the present exposure apparatus, the cumulative amount of light of the respective pulsed lights that illuminate each point in the field on the wafer exposed to the pattern image of the reticle R can be regulated with a suitable value depending on the sensitivity of the resist on the wafer either by regulating the intensity of the pulsed light on the wafer by modifying at least one of the generation intensity of the light source 3 or the light transmittance (attenuation rate), or by regulating the number of pulsed lights that illuminate each point on the wafer W by modifying at least one of the width in the scanning direction of the pulsed light on the wafer W, the generated frequency of the light source 3, or the scanning speed of the wafer W.

As shown in FIG. 1, on the reticle R, a pattern field 36 is set in order to form the pattern to be transferred to the wafer W, and on the circumference of the pattern field 36, a light shield band 37 is formed with Cr, for example, in order to shield the exposure light. In addition, outside the pattern field 36, measuring fields 38a and 38b, which are rectangular in planar view and transmit a part of the exposure light, are set at particular positions in the scanning direction (the vertical direction in FIG. 1) so as to surround the pattern field 36 on both sides. The measuring fields 38a and 38b are used to measure the change in the amount of exposure light, and are respectively set in proximity to the center of the pattern field 36 in the non-scanning direction (to horizontal direction in FIG. 1).

Moreover, in the case that the outside of the pattern field 36 becomes a completely shielded part, these measuring fields 38a and 38b are set by excluding the light shielding part at the above-mentioned predetermined position and allowing the transmission of light. In addition, in the case that the outside of the pattern field 36 does not become a completely light shielding part, the measuring fields 38a and 38b are set to serve as a virtual field.

In contrast, at the outside of the pattern 36, six reticle alignment marks 39, . . . , 39 used during alignment are respectively formed so as to be positioned in the non-scanning direction to surround the pattern field 36 on both sides. In addition, above the reticle R, a reticle alignment system (not illustrated) is provided for detecting these reticle alignment marks 39, . . . , 39.

The reticle R is held and anchored on the reticle stage (mask stage) by the reticle holder 22. On the reticle stage 23, a through hole 23a (illustrated only in part) is formed such that the exposure light that transits the pattern field 36 and the measuring fields 38a and 38b can be transmitted. In addition, the reticle stage 23 is provided on the base 24 so as to move along the inner surface perpendicular to the surface of the FIG. 2. A reflecting mirror 25 is disposed on the reticle holder 22. The position of the reticle stage 23 is measured by the laser light emitted from the laser interferometer 26 being reflected by the reflecting mirror 25 and incident on the laser interferometer 26. The measured position information is input into the main controller 16. The main controller 16 drives the motor 27 for driving the reticle stage, and controls the position of the reticle R and the scanning speed of the reticle R during scanning exposure, for example, based on this input position information.

The wafer W is held and anchored on the wafer stage 29 by the wafer holder 28. The wafer stage 29 is provided so as to move along the inner surface perpendicular to the surface of FIG. 2. A reflecting mirror 30 is provided on the wafer stage 29. The position of the wafer stage 29 is measured by the laser light emitted from the laser interferometer 31 being reflected by the reflecting mirror 30, and made incident to the interferometer 31. The measured position information is input into the main controller 16. The main controller 16 drives the motor 32 for driving the wafer stage 32, and controls the position of the wafer W and the speed of the wafer W during scanning exposure, for example, based on the input position information.

In addition, on the wafer stage 29, an illumination intensity sensor (the second receiving optical means) 33 comprising optoelectric conversion elements and an irradiation amount monitor 34 are provided such that their respective receiving light surfaces substantially conform to the surface of the wafer W. The illumination intensity sensor 33 receives the exposure light irradiating the wafer W, detects this illumination intensity (specifically, the exposure energy per unit of surface area), and is positioned at two locations corresponding to the measuring fields 38a and 38b. The signal corresponding to the illumination intensity detected by the illumination intensity sensor 33 is output to the main controller 16. The irradiation amount monitor 34 detects the total amount of energy of the exposure light, and the detected signal is output to the main controller 16. Moreover, in the case that the illumination intensity sensor 33 is positioned corresponding to either one of the measuring fields 38a or 38b and receives the exposure light that transits the other one of the measuring fields 38a or 38b, the illumination intensity sensor 33 can be moved via the stage 29.

Below, the operation of the reticle (mask) and the exposure apparatus having the above structure are explained.

First, the illumination intensity sensor 33 is calibrated in advance using the irradiation amount monitor 34. Specifically, the irradiation amount monitor 34 is moved on the optical axis of the projection optical system 11 while the reticle R is not set on the reticle stage 23, and at the same time the laser light source 3 is activated. Then the exposure light from the laser light source 3 is received at the integrator sensor 15 via the beam splitter 14, and thereby the output signal S1 is measured. At the same time, the exposure light that transited the projection optical system 11 is received by the irradiation amount monitor 34, and thereby the output signal S2 is measured. Next, the coefficient α is selected such that the calculated signals S1 and S2 satisfy the following equation:

S1×α=S2

Then the illumination intensity sensor 33 is moved on the optical axis of the projection optical system 11, and by receiving the exposure light, the output signal S3 is calculated. In addition, by using the above coefficient α to adjust the gain of the output signal S3 of the illumination irradiation sensor 33 so as to satisfy the following equation, the calibration of the illumination intensity sensor 33 is completed:

S1×α=S3

Moreover, this calibration procedure is only one example thereof, and other possible procedures would include adjusting the gain of the output signal S1 with respect to the fixed coefficient α and the output signal S2, and then, using this output signal S1 as a reference, adjusting the gain of the output signal S3 of the illumination intensity sensor 33, or carrying out calibration of the output signal of the illumination intensity sensor 33 using the fixed coefficient α and the first output signal S2, and then adjusting the gain of the output signal S1 of the integrator sensor 15 using the output signal S2 as a reference.

When the calibration of the illumination intensity sensor 33 has been completed, the illumination intensity irregularity of surface of the wafer W is calculated using this illumination intensity sensor 33. Specifically, the entire projective field of the projection optical system 11 is scanned by the illumination intensity sensor 33 by activating the wafer stage 29. At this time, the coordinates of the illumination intensity sensor 33 are read out via the laser interferometer 31. At the same time, the exposure light emitted from the laser light source 3 is received by the integrator sensor 15 and the illumination intensity sensor 33. The main controller 16 calculates the ratios LW/L1 of the outputs L1 of the integrator sensor 15 and the outputs LW of the illumination intensity sensor 33, and these ratios are stored in a format that associates them with coordinates.

Then, by the reticle loading mechanism (not illustrated), the reticle R forming the pattern that is the object of transfer is conveyed onto the reticle stage 23 and mounted. At this time, the reticle alignment mark 39 is detected by the reticle alignment system, and based on this result, the position of the reticle R is set by a reticle position control circuit (not illustrated) so that the reticle R is disposed at a specified position.

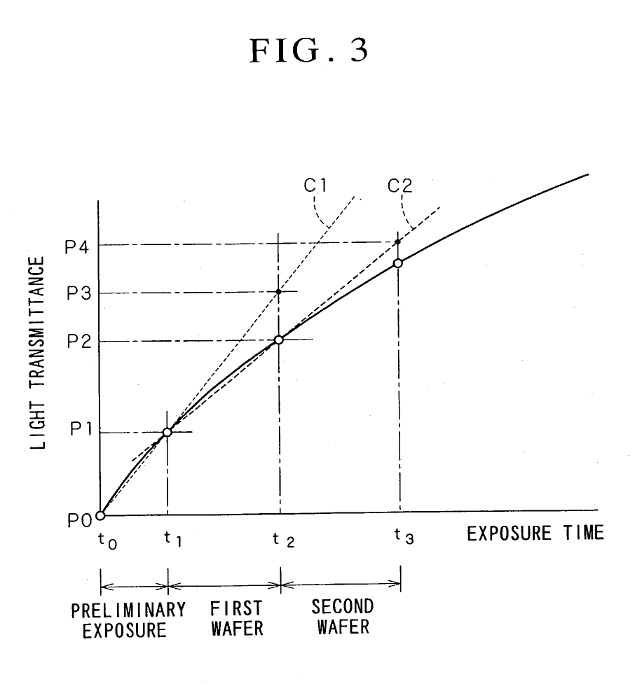

Next, before starting the exposure processing, the light transmittance time change prediction line (light transmittance time change properties) of the projection optical system 11, denoted by the reference symbol C1 in FIG. 3, is calculated. FIG. 3 is a graph in which the horizontal axis denotes the exposure time and the vertical axis denotes the light transmittance. The light transmittance shown in this graph is the light transmittance of the optical system (hereinbelow, referred to as the “light transmittance measuring optical system”) from the beam splitter 14 that splits off exposure light going to the integrator sensor 15, to the wafer W surface.

First, the reticle stage 23 and the wafer stage 29 are moved, and among the measuring fields 38a and 38b of the reticle R and the illumination intensity sensors 33 and 33, the one nearest to the optical axis of the projection optical system 11 is positioned on the optical axis of the projection optical system 11, the laser optical source 3 is activated, and a 20000 pulse preliminary exposure is carried out. Thereby, one part of the exposure light emitted from the laser light source 3 is input into the integrator sensor 15, and the other part is input into the illumination intensity sensor 33 after transiting the light transmittance measuring optical system and the measuring field 38a of the reticle R. Here, for example, in synchronicity with the first pulse, the integrator sensor 15 and the illumination intensity sensor 33 respectively receive the exposure light, and inputs its illumination intensity. The current ratio LW/L1 of the output L1 of the integrator sensor 15 and the output LW of the illumination intensity sensor 33 is calculated. In FIG. 3, this is the light transmittance PO at the time that the exposure began.

Next, for example, in synchronicity with the 20001^{st} pulse, the integrator sensor 15 and the illumination intensity sensor 33 respectively receive the exposure light, and its illumination intensity is input. At this time, the current ratio LW/L1 of the output L1 of the integrator sensor 15 and the output LW of the illumination intensity sensor 33 is calculated. In FIG. 3, this is the light transmittance P1 at exposure time t1.

Due to the light cleaning effect of the preliminary exposure of the laser pulses, the hydrous component and organic substances adhering to the surface of the light transmittance measuring optical system included in the projection optical system 11 are stripped off, the light transmittance of the light transmittance measuring optical system is improved, and the light transmittance P1>P0. By connecting the two light transmittances P1 and P0 with a straight line, the light transmittance time change prediction line C1 can be calculated. This straight line C1 is stored as the first order function, or stored as a table of the light transmittances with respect to the exposure time. Moreover, this calculation and storage are carried out by the main controller 16.

When the light transmittance time change line C1 has been determined, the first wafer W is placed facing the optical axis of the projection optical system 11. On the surface of the wafer W, a resist, which is a photosensitive substance, has been applied in advance, and in this state, the wafer W is conveyed by a wafer loading mechanism (not illustrated), and disposed at a predetermined position on the wafer stage 29 using, for example, the outside diameter as a reference. The wafer W is aligned on the wafer stage 29, and held and anchored.

Subsequently, by the variable field stop 10, the pattern on the reticle R is selectively illuminated by exposure light that has, for example, a slit shape that extends in the non-scanning direction, and the reticle R is moved relative to this illuminated field by the reticle stage 23. At the same time, the wafer is moved by the wafer stage 29 relative to the projective field conjugate to this illuminated field with respect to the projection optical system 11. In other words, the reticle R and the wafer W move in synchronism in the scanning direction with respect to the exposure light. Thereby, the pattern formed by the reticle R is sequentially transferred to the projective field on the wafer W.

Moreover, when this exposure begins, the reticle R becomes equal to the post-entrant speed, and immediately before the pattern field 36 of the reticle R arrives at the illuminated field, the variable field stop 10 is opened, and thereby a particular field on the reticle R is illuminated. When the exposure has completed, the variable field stop 10 is closed when the light shield band 37 of the reticle R has reached the illuminated field, and the exposure light is blocked.

When the exposure begins, the main controller 16 calculates the gain G1 by multiplying the specified coefficient K by the ratio (LW/L1) of the output L1 of the integrator sensor 15 and the output LW of the illumination intensity sensor 33. In addition, during the exposure operation, the output signal of the integrator sensor 15 is multiplied by the gain G1, and the estimated actual illumination intensity L on the wafer W is output. This gain G1 is set to the optimal value in the case that there is no fluctuation of the light transmittance.

The estimated actual illumination intensity L is further multiplied by the gain G2, and the estimated actual illumination intensity LC on the wafer after compensation is calculated. This gain G2 is calculated by finding the light transmittance from the time elapsed from the beginning of the exposure and the stored light transmittance time change prediction line C1, and then multiplying the calculated light transmittance by the predetermined coefficient K2. Moreover, when the pattern image is projected on the wafer W between time points t1 to t2 in FIG. 3, the light transmittance used during the exposure between t1 and t2 is calculated from the light transmittance time change prediction line C1 based on the elapsed time therebetween (the exposure time). In addition, the main controller 16 calculates the deviation between the target illumination intensity on the wafer W that is set in advance and the calculated estimated actual illumination intensity LC, and the generation strength, that is, the amount of light, of the laser light source 3 is regulated via a light source control circuit so as to compensate this deviation. Thereby, the change in properties of the amount of light with respect to the exposure light through time is predicted, and the amount of light can be compensated based on the results of this prediction.

In the case of FIG. 3, at time point t2, when the exposure of a projective field on the first wafer W has completed, as described above, the variable field stop 10 is closed, and at the same time, the reticle stage 23 and the wafer stage 29 are moved, and among the measuring fields 38a and 38b of the reticle R and the illumination intensity sensors 33 and 33, the one positioned closest to the optical axis of the projection optical system 11 is positioned on the optical axis of the projection optical system 11. In addition, by a procedure similar to that described above, at time t2, the light transmittance P2 is calculated from the ratio LW/Li of the output L1 of the integrated sensor 15 and the output LW of the illumination intensity sensor 33 and stored, and at the same time, the light transmittance P1 at time t1 and the light transmittance P2 at time t2 are connected, and the light transmittance time change prediction line C2 is calculated.

Next, when the exchange of the wafer W has been carried out by the wafer loading mechanism, and the second wafer W has been disposed at a predetermined position on the wafer stage 29, the exposure of the wafer W is commenced. Like the first exposure, the light transmittance of this exposure is also calculated from the elapsed time between times t2 to t3 based on the light transmittance time change prediction line C3, and the amount of exposure is controlled using the gain G2 calculated from this light transmittance.

Moreover, in the case of transferring a pattern to the wafer W from the second time, the pattern is present on the wafer W. Therefore, by measuring the marks attached to the already transferred pattern using the wafer alignment system (not illustrated), the positions of the reticle stage 23 and the wafer stage 29 are controlled so that the pattern to be transferred has a predetermined positional relationship with respect to the pattern previously transferred onto the wafer W.

In addition, when exposing the third wafer W and thereafter, the light transmittance time change prediction line can be calculated using the same procedure that was used for the second wafer W, or the light transmittance can also be found by calculating the change in slope between the light transmittance time change prediction lines C1 and C2, rather than carrying out preliminary exposure by activating the laser light source 3. That is, from the change in slope of the two previous prediction lines, the next prediction line can be calculated.

In the mask and the exposure apparatus of the present embodiment, the exposure light transits the measuring fields 38a and 38b set by the reticle R, and thus when measuring the amount of light by the illumination intensity sensor 33, in addition to replacement of the reticle R at that time becoming unnecessary, a higher precision light exposure control can be carried out because the amount of exposure light that actually transits the reticle R can be measured. Thus, the light amount measurement can be carried out frequently, and even if the light transmittance of the light transmittance measuring optical system fluctuates due to light cleaning, the target illumination intensity on the wafer W can be maintained easily and accurately. In addition, the reticle stage 23 has the original entrant stroke, and if measuring fields 38a and 38b are provided on the reticle R, the exposure light transits the measuring fields 38a and 38b within this stroke, and thus the stroke does not have to be made any longer than necessary, and enlarging the size and increasing the cost of the apparatus can be avoided.

In addition, in the mask and exposure apparatus of the present embodiment, the measuring fields 38a and 38b are set outside the pattern field 36, and thus, even if substantially the entire pattern field is shielded, as with a reticle for contact hole formation, there is no obstacle to the light amount measurement by the illumination intensity sensor 3, and the amount of exposure light can be accurately compensated.

Furthermore, in the mask and exposure apparatus of the present embodiment, the measuring fields 38a and 38b are set in the scanning direction surrounding the pattern field 36 on both sides, and thus after scanning exposure, even when the reticle stage 23 is moved for measuring the amount of light, the measuring field closest to the optical axis of the projection optical system 11 can be selected. Therefore, the movement distance of the reticle stage can be made short, and improvement of the cycle time of the exposure process can be realized. In addition, the measuring fields 38a and 38b are set at the center of the pattern field 36 in the non-scanning direction, and thus the amount of exposure light that transits in proximity to the center, the most important light, in the projection optical system 11 can be measured, and higher precision exposure light amount control is realized. Moreover, similar effects can be attained even when using only one of the measuring fields 38a or 38b.

In addition, in the mask and exposure apparatus of the present embodiment, the time change properties of the amount of exposure light can be predicted by calculating the light transmittance time change prediction line, and based on the results of this prediction, the amount of light can be compensated. Therefore, the wafer W can be suitably exposed even when the light transmittance of the illumination system and the light transmittance measuring optical system 11 of the projection optical system fluctuate during the exposure and suspension of the apparatus. For example, the illumination intensity on the wafer W can be compensated by an appropriate value, and the cumulative amount of the exposure light (the exposure dose) on the wafer W can always be compensated by a suitable value depending on the sensitivity of the wafer W.

Second Embodiment

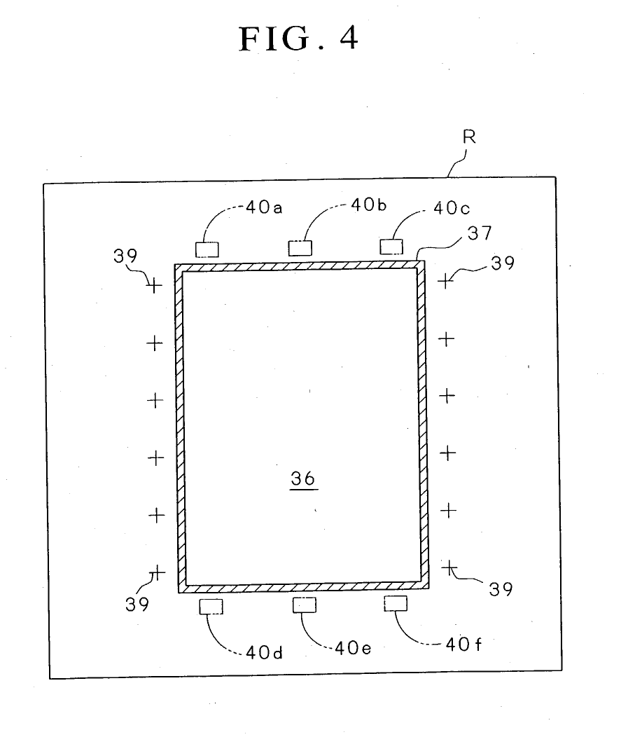

FIG. 4 is a drawing showing a second embodiment of the mask and exposure apparatus of the present invention. In the figure, the essential elements that are identical to those in the first embodiment shown in FIG. 1 through FIG. 3 have identical reference symbols, and their illustration and explanation are omitted.

The point on which the second embodiment differs from the first embodiment is the structure of the measuring fields in the reticle R, and the method of calculating the light transmittance.

Specifically, as shown in FIG. 4, on the outside of the pattern field 36 of the reticle R, the measuring fields 40a to 40c and 40d to 40f are positioned in the scanning direction surrounding the pattern field 36 on both sides, and are respectively set in the non-scanning direction along the pattern field 36. The measuring fields 40b and 40e are disposed respectively in proximity to the center of the pattern field 36 in the non-scanning direction. The measuring fields 40a, 40c, 40d, and 40e are disposed respectively in proximity to the ends of the pattern field 36 in the non-scanning direction. In addition, on the wafer stage 29, illumination intensity sensors 33, . . . , 33 are disposed at six locations corresponding to the respective measuring fields 40a to 40f.

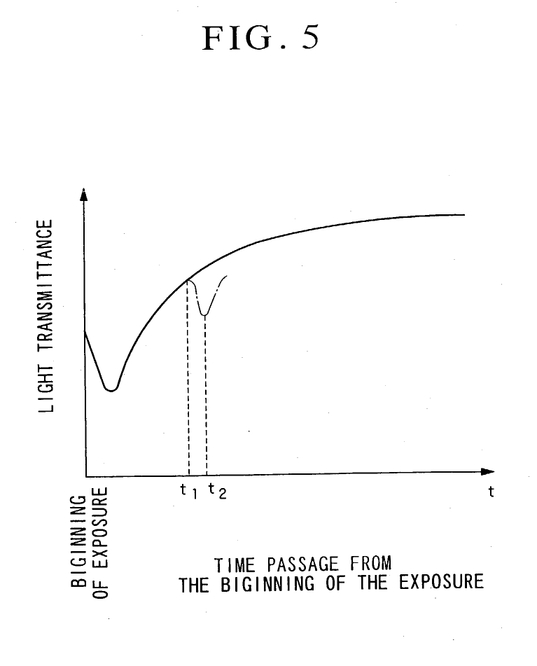

At the same time, in the main controller 16, as shown by the solid line in FIG. 5, the time change properties of the light transmittance are measured and stored in advance as a table that associates the exposure conditions that are respective combinations of the type of the pattern of the reticle R, the illumination conditions that depend on the type of reticle R, and the aperture number of the projection optical system. The other components are identical to those of the first embodiment.

In the mask and exposure apparatus having the above-described structure, the light transmittance is read out based on the elapsed time from the beginning of the exposure operation by referring to a table categorized by the exposure conditions that have been set. In addition, the amount of the laser light source 3 can be regulated using this light transmittance by the same procedure as that in the above-described first embodiment.

In addition, each time a wafer W is exchanged, when the amount of exposure light is measured, the reticle stage 23 and the wafer stage 29 are moved, and among the measuring fields 40a to 40c, and 40d to 40f of the reticle and the illumination intensity sensors 33, . . . , 33, the one nearest the optical axis of the projection optical system 11 (40a to 40c, and 33, . . . , 33) is positioned on the optical axis. In addition, the exposure light emitted from the laser light source 3 is received by the integrator sensor 15, and at the same time is received at the illumination intensity sensors 33, . . . 33 via the measuring fields 40a to 40c. Next, by averaging the output of each respective sensor, the amounts of light that reduce the influence of the distortion, etc., of the optical elements can be found.

In addition, the light transmittance of the light transmittance measuring optical system can be calculated from these light amounts, and compared with the time change curve of the light transmittance set in the table. In the case that the light transmittance obtained from this curve and the light transmittance actually calculated measurement deviate from each other, the curve set by the table is offset by compensation such that the calculated light transmittance is positioned on the curve, and then stored. Subsequently, until the next light amount measurement, the light transmittance is read from this offset compensated curve and used.

In the mask and exposure apparatus of the present invention, the same results as those attained in the above-described first embodiment are attained, and at the same time, by receiving the exposure light that transits the plurality of measuring fields 40a to 40c, the amounts of light that reduce the influence of the distortion, etc., of the optical elements, can be found, and a higher precision light exposure control can be carried out. In addition, because the light transmittance change during exposure is also stored in a table in advance, the light transmittance associated with an elapsed time can be quickly determined.

Moreover, the above-described embodiment has a structure wherein the measuring fields 38a, 38b, and 40a to 40f were set outside the pattern field 36, but these fields are not limited thereby, and can be set inside the pattern field 36 if one part of the exposure light can transit therethrough, and they are set in advance at a particular positions. In this case, the exposure light need not transit all of the measuring fields, and only a part of this pattern needs to be included in the measuring field.

In addition, a structure can be used wherein the measuring fields 38a, 38b, and 40a to 40f are set in the scanning directions surrounding the pattern field 36 on both sides, but they can be set on one side only, and furthermore, as long as the movement stroke of the reticle 23 in the non-scanning direction is maintained, they can also be set in the non-scanning direction on both sides. In addition, setting the measuring fields 38a, 38b, and 40a to 40f in proximity to the center in the non-scanning direction is not always necessary, and they can be set on the edges. In the case that a plurality is set in the non-scanning direction, the setting is not limited to three locations, but can be set at two or four or more locations. In the case that the projection optical system 11 is formed using a plurality of projective lenses, which is termed a multi-lens system, if a measuring field is set for each projective lens, a higher precision light exposure control can be carried out.

In addition, in the above-described embodiment, a preliminary development of 20001 pulses is carried out between times t0 to t1, but the number of pulses is not limited to 20001 pulses. In addition, the light transmittance was predicted by calculating the light transmittance time change prediction line respectively connecting the two time points t0 and t1 and time points t1 and t2, but a light transmittance calculated with three or more points can be used. The calculation can be carried out using an approximation method or a straight line approximation, in addition to using a recursive line or recursive curve that do not connect the calculated light transmittances directly.

The above-described embodiment is structured such that the generation intensity of the laser light source 3 is regulated in order to compensate the deviation between the target illumination intensity and the estimated actual illumination intensity, but the structure is not limited thereto. As described above, the cumulative amount of exposure light can be controlled with a suitable value according to the sensitivity of the resist of the wafer W by regulating the light transmittance of the pulsed light of the laser light source 3 by a turret plate TP, or regulating the number of pulsed lights illuminating each point on the wafer W by changing at least one of the width of the light pulse in the scanning direction on the wafer W, the generation frequency of the laser light source 3, or the scanning speed of the wafer W.

At the same time, in the above-described embodiment, in order to increase the throughput, a sequence is established in which the measurement of the amount of exposure light is carried out by an illumination intensity sensor 33 each time the wafer W is exchanged, but in the case that the fluctuation of the light transmittance during the exposure is large and cannot be ignored, the exposure amount measurement can be carried out for each shot for one wafer W in order to carry out higher precision exposure amount compensation, or exposure amount measurement can be carried out for each pulse depending on the type of the light source. In addition, a structure was employed wherein the illumination intensity sensor 33 for measuring illumination intensity irregularity also measures the light exposure can be used, but the sensor for the exposure amount measuring can be provided separately.

Furthermore, in the case that the light transmittance of the projection optical system 11 does not fluctuate or fluctuates slightly, the time change characteristics of the light transmittance need to be found only for the illuminating optical system. In this case, an illumination intensity sensor 33 can be disposed on the reticle stage 23, and the light transmittance is measured based on the output values of the integrator sensor 15 and this illumination intensity sensor 33. In contrast, in the case that the light transmittance of the illumination optical system does not fluctuate or fluctuates slightly, the time change properties of light transmittance only need to be found for the projection optical system 11. In this case, the illumination intensity can be measured by splitting off exposure light between the illumination optical system and the projection optical system 11.

Moreover, a structure employing a variable field stop 10 as a means of shielding the exposure light illuminating the reticle R was used, but this means is not limited to this structure. For example, a shutter can be provided between the laser light source 3 and the chamber 6, and the exposure light can be shielded or the shielding released by opening and closing the shutter.

Moreover, as a substrate for the present invention, not only a semiconductor wafer for a semiconductor device, but also a glass plate for a liquid crystal display device, a ceramic wafer for a thin film magnetic head, or the lithographing using a mask or reticle (compound silicate, silicone wafer) can be used.

In addition, the exposure apparatus 1 of the present invention can be adapted not only to a scanner type projective apparatus (U.S. Pat. No. 5,473,410) using a step and scan method that exposes the pattern of the reticle R by moving the reticle R and wafer W in synchronism, an apparatus which is called a scanning stepper, but also to a step and repeat type exposure apparatus (stepper) that exposes the pattern of the reticle R while the reticle R and wafer W are a stationary state, and moves the wafer W is sequential steps, can be used. The regulation of the exposure amount with a stepper regulates at least one of the intensity of the exposure light (the generation intensity of the pulsed light source, etc.) on the wafer W and the pulse number. In addition, in the case that a continuous light is used as the exposure light, at least one among the intensity of the exposure light (the generation intensity of the light source, etc.) on the wafer W or the illumination time thereof is regulated. In addition, this exposure apparatus 1 can be adapted to a proximity exposure apparatus that exposes the wafer W to the pattern of the reticle R by placing the reticle R and wafer W in direct contact, without using a projection optical system 11.

The use of the exposure apparatus 1 is not limited to exposure apparatuses for semiconductor manufacturing. For example, it can be adapted to exposure apparatuss for liquid crystals that expose a liquid crystal display element pattern to an angular glass plate and an exposure apparatus for fabricating thin film magnetic heads, image pickup devices (CCDs), or reticles R.

Moreover, the above-described example explains the case of using an ArF laser as an exposure light, but the present invention can be adapted to exposure apparatuses using a KrF laser, and a EUVL, such as a short wavelength soft X-rays. In addition, the light transmittance of the optical system was measured at a plurality of time points using the exposure light, but a separate light source that emits a light having a wavelength substantially identical to that of the exposed light can be used.

The magnification of the projection optical system 11 can be either an equalizing or enlarging system, not just a reducing system. In addition, for the projection optical system 11, in the case of using an ultraviolet radiation of, for example, an excimer laser, a material that transmits ultraviolet radiation, such as silicon and fluorite, serves as a glass material. In the case of using an F₂ laser, a reflective-refractive or refractive optical system can be used (a reflective-type reticle R is also used).

In the case that a linear motor is used on the wafer stage 29 and the reticle 23 (refer to U.S. Pat. Nos. 5,623,853 and 5,528,118), either an air floatation-type using an air bearing or magnetic floatation-type using the Lorentz force or a reactance force can be used. In addition, each of the stages 29 and 23 can be a guide type that moves along a guide, and can be a guideless type that is not provided with a guide.

A flat motor that has a magnetic unit providing magnets disposed two dimensionally opposite to an electric unit providing coils disposed two dimensionally, and activates a stage with electromagnetic force can be used as the drive apparatus for the stages 23 and 29. In this case, either the magnetic unit or the electric unit is connected to one stage, and the other one thereof is connected to the moving surface of other stage.

The reactive force generated by movement of the wafer stage 29 is mechanically discharged in the floor (ground) by using a frame member, as is disclosed in Japanese Unexamined Patent Application, First Publication, No. Hei 8-166475 (U.S. Pat. No. 5,528,118).

The reactive force generated by the movement of the reticle stage 23 can be mechanically discharge to the floor (ground) by using a frame member, as is disclosed in Japanese Unexamined Patent Application, First Publication, No. Hei 8-330224 (U.S. Ser. No. 08/416,558).

The exposure apparatus 1 of the present embodiments can be fabricated by combining an illuminating optical system and a projection optical system 11 comprising a plurality of optical elements serving as an exposure apparatus body 2, and the optical regulation thereof carried out, and at the same time, by installing the reticle stage 23 and the wafer stage 29 comprising a plurality of mechanical components on the exposure apparatus body 2, connecting wiring and conduits, and then carrying out comprehensive adjustment (electrical adjustment, operation confirmation, etc.). Moreover, the fabrication of the exposure apparatus 1 is preferably carried out in a clean room in which the temperature and the degree of cleanliness are controlled.

The semiconductor device is fabricated via the following steps: a step of designing the functions and capacities of each device; a step of fabricating the reticle based on the design step; the step of fabricating a wafer W from the silicon material; a step of exposing a pattern of the reticle R onto a wafer W using the above-described embodiment of the exposure apparatus 1; a step of assembling each device (including a dicing process, a bonding process, a packaging process); and an inspection step.

What is claimed is:

1. A mask comprising:
a pattern illuminated with exposure light; and
measuring fields that transmit the part of the exposure light used in measuring the amount of said exposure light.

2. A mask according to claim 1 wherein said measuring fields are set outside the pattern field that forms said pattern.

3. A mask according to claim 2 wherein said measuring fields are set surrounding said pattern field on both sides.

4. A mask according to claim 3 wherein said measuring fields are set respectively in proximity to the center of said pattern field.

5. A mask according to claim 3 wherein said measuring fields are respectively set in plurality along said pattern field.

6. A mask according to claim 4 wherein said measuring fields are respectively set in plurality along said pattern field.

7. An exposure apparatus comprising:
a mask stage that holds a mask having a pattern field and measuring fields that transmit the part of exposure light used in measuring the amount of said exposure light;
an illumination optical system that illuminates said mask by said exposure light;
a projection optical system that transfers the pattern of said mask to a substrate;
a first receiving light sensor that receives a part of said exposure light that illuminates said mask;
a second receiving light sensor that receives said exposure light that transits the measuring fields of said mask and said projection optical system; and
a light amount compensator that compensates the amount of said exposure light based on the output signal of said first receiving light sensor and said second receiving light sensor.

8. An exposure apparatus according to claim 7 wherein said light amount compensator predicts the time change properties of the amount of said exposure light form said output signal, and compensates said amount of light based on the results of this prediction.

9. An exposure apparatus according to claim 7 providing a synchronous movement system connected with mask and substrate to synchronously move said mask and said substrate with respect to said exposure light, and said measuring fields are set surrounding the pattern fields that form said patterns on both sides in the direction of said synchronous movement.

10. An exposure apparatus according to claim 8 providing a synchronous movement system connected with mask and substrate to synchronously move said mask and said substrate with respect to said exposure light, and said measuring fields are set surrounding the pattern fields that form said patterns on both sides in the direction of said synchronous movement.
